(19) United States
(12) Patent Application Publication
(10) Pub. No.: US 2009/0171946 A1
(43) Pub. Date: Jul. 2, 2009

(54) METHOD FOR ANALYZING TECHNOLOGY DOCUMENT

(75) Inventors: Yan-Ru Li, Taipei County (TW); Leuo-Hong Wang, Taipei County (TW); Chao-Fu Hong, Taipei County (TW); Guo-En Tong, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ALETHEIA UNIVERSITY, Taipei County (TW)

(21) Appl. No.: 12/136,059

(22) Filed: Jun. 10, 2008

(30) Foreign Application Priority Data
Dec. 31, 2007 (TW) 96151566

(51) Int. Cl. G06F 7/20; G06F 17/30

(52) U.S. Cl. 707/5; 707/E17.014

(57) ABSTRACT

A method for analyzing a technology document is adapted to a technology document and includes providing a technology structure network. The technology structure network has several technology category groups representing several technology categories correspondingly. Each technology category group is a technology hierarchical class having several technology levels from top to bottom and each technology level has at least one technology node. Then, statistics for terms are calculated to analyze a content of the technology document so as to find out at lest one particular term. Next, a co-occurrence correlation is established between each of the particular terms and each of the technology nodes in the technology structure network. Then, according to the correlations, a technical field of the technology document is identified.

### BACKGROUND OF THE INVENTION

1. Field of the Invention

The present invention relates to an analyzing method, and particularly to an analyzing method for a technology document.

2. Description of Related Art

A common document analysis is conducted on a single-word or a single-term basis to calculate a frequency of use for words used in a document. However, simply taking apart terms used in a technology document to obtain a correlation diagram among each of the terms cannot identify immediately a technical field or a trend of which a content of the technology document is a part. Furthermore, when a technology just begins to develop, relevant technology documents, such as patent files, published patent applications, academic papers and seminar records, do not frequently mention phrases or terms related to the latest developing technology, and even technical terms or vocabulary directly related to the latest developing technology are seldom used in the foregoing technology documents. Therefore, if a technology document is analyzed on a single-phrase, single-word basis, it is possible that the relevant terms and vocabulary related to the latest developing technology, because of their low frequency of use, are excluded from the correlation diagram of the terms and vocabulary used in the technology document. Hence, it is difficult to discover a direction where the latest developing technology implied in the technology document is heading simply through the correlation diagram of the terms and vocabulary.

Moreover, in existing methods of searching for patents and technical features, art classification numbers, key words and terms of a technology are used to search for related technology documents in a document database, but analyzing a content of a certain technology document to identify a related technical field of the certain technology document still requires manpower to inspect the content of each of the documents and thereby distinguish among them. Nevertheless, when a total number of technology documents to be analyzed is enormous, such methods for patent and technical feature searches not only demand considerable human and material resources, but also consume much time of working staff on the searches for patents and technical features. Consequently, analyses in terms of the technical field and trend of the related new technology for a large amount of technology documents cannot be promptly completed within a short period of time.

### SUMMARY OF THE INVENTION

The present invention is related to a method for analyzing a technology document, capable of assisting users in rapidly grasping correlation among technology categories of the technology document to be analyzed.

The present invention is further directed to a method for analyzing a technology document, capable of discovering a latest developing technology in a related technical field through analyzing the technology document.

The present invention provides a method for analyzing a technology document, adapted to a technology document. The method includes providing a technology structure network. The technology structure network has a plurality of technology category groups representing a plurality of technology categories correspondingly. Each of the technology category groups is a technology hierarchical class having from top to bottom a plurality of technology levels. Each of the technology levels has at least one technology node. Afterwards, a term statistic is performed to analyze a content of the technology document and sift out at least one particular term from the technology document. Thereafter, a co-occurrence correlation is established between each of the particular terms and each of the technology nodes in the technology structure network. Next, a technical field of the technology document is identified according to the co-occurrence correlations.

According to a method for analyzing a technology document in a preferred embodiment of the present invention, a method for forming the technology structure network includes providing a data set based on a technical subject. The data set includes a plurality of data documents related to the technical subject. Later, each of the data documents is analyzed to obtain a plurality of key terms. Afterwards, the key terms are grouped to form the technology category groups. Then, the technology structure network is established based on correlations among the technology nodes. The key terms do not include the particular terms. In addition, a step of analyzing each of the data documents further includes calculating statistics for a term occurrence frequency of each of the key terms, obtaining the correlation between each of the key terms and the other key terms, and concluding a particular correlation between each of the key terms and the technical subject. Additionally, a step of grouping the key terms to form the technology category groups further includes defining a portion of the key terms as the technology categories respectively according to the term occurrence frequency of each of the particular terms, the correlations and the particular correlations. Moreover, a step of grouping the key terms to form the technology category groups further includes grouping the key terms to each of the technology category groups after the portion of the key terms are defined as the technology categories. Then, the technology hierarchical class of each of the technology category groups is established with the key terms of each of the technology category groups. Furthermore, in each of the technology hierarchical classes, with the technology category as a parent level, each of the technology categories has a plurality of technology structures to serve as the technology nodes at a first child-level under the parent level. Each of the technology structures has a plurality of related key terms to serve as the technology nodes at a second child-level under the first child-level.

According to a method for analyzing a technology document in a preferred embodiment of the present invention, identifying the technical field of the technology document further includes identifying the technical field related to the particular terms.

According to a method for analyzing a technology document in a preferred embodiment of the present invention, the particular terms include rare key terms or latest created terms.

The present invention further provides a method for analyzing a technology document, adapted to a technology document. The method includes providing a technology structure network having a plurality of technology hierarchical classes. Term statistic is performed to analyze a content of the technology document and sift out at least one particular term. Later, a co-occurrence correlation is established between each of the particular terms and at least one among the first technology nodes and the second technology nodes in the technology structure network. Next, a technical field of the technology document is identified according to the co-occurrence correlations. Each of the technology hierarchical classes at least includes a technology category level, a technology structure level and a related key term level. The technology category level has a parent node to represent a technology category. The technology structure level is a first level of the technology category level. The technology structure level has a plurality of first technology nodes. Each of the first technology nodes represents a technology structure element of the technology category. The related key term level is a second level of the technology structure level and has a plurality of second technology nodes. Each of the second technology nodes represents a related key term. The related key term is correlated to the first technology node of a corresponding parent node serving as the second technology node.

According to a method for analyzing a technology document in a preferred embodiment of the present invention, a method for forming the technology structure network includes providing a data set based on a technical subject. The data set includes a plurality of data documents related to the technical subject. Later, each of the data documents is analyzed to obtain a plurality of key terms. Afterwards, the key terms are grouped to form the technology hierarchical classes. Then, the technology structure network is established based on correlations among the technology nodes. The key terms do not include the particular terms. In addition, a step of analyzing each of the data documents further includes calculating statistics for a term occurrence frequency of each of the key terms, obtaining the correlation between each of the key terms and the other key terms, and concluding a particular correlation between each of the key terms and the technical subject. Additionally, a step of grouping the key terms to form the technology hierarchical classes further includes defining a portion of the key terms as the technology categories respectively according to the term occurrence frequency of each of the key terms, the correlations and the particular correlations. Moreover, a step of grouping the key terms to form the technology hierarchical classes further includes grouping the key terms to each of the technology categories after the portion of the key terms are defined as the technology categories. Then, each of the technology hierarchical classes is established with the key terms of each of the technology categories.

According to a method for analyzing a technology document in a preferred embodiment of the present invention, at least one among the first technology nodes each having each of the second technology nodes is a sub-node of the first technology node.

According to a method for analyzing a technology document in a preferred embodiment of the present invention, identifying the technical field of the technology document further includes identifying the technical field related to the particular key terms.

According to a method for analyzing a technology document in a preferred embodiment of the present invention, the particular terms include rare key terms or latest created terms.

In the present invention, an occurrence frequency of each term in the data document of the data set is calculated to establish a technology structure network. After the occurrence frequencies of the terms in a technology document are analyzed, a particular term network of the technology document is established. Through interconnecting and correlating nodes representing particular terms in the particular term network to each of technology nodes in the technology structure network respectively, a related technical field of the particular terms in the technology document is clearly identified and a direction of technology research and development in the technology document is promptly grasped so as to discover a latest developing technology in the related technical field.

In order to make the aforementioned and other objects, features and advantages of the present invention more comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a method for analyzing a technology document according to a preferred embodiment of the present invention.

FIG. 2 illustrates a method for forming a technology structure network according to a preferred embodiment of the present invention.

FIG. 3 illustrates a technology structure table according to a preferred embodiment of the present invention.

FIG. 4 illustrates a technology structure network formed by the technology structures of FIG. 3.

FIG. 5 illustrates a simplified relation diagram among particular terms of a technology document according to a preferred embodiment of the present invention.

### DESCRIPTION OF EMBODIMENTS

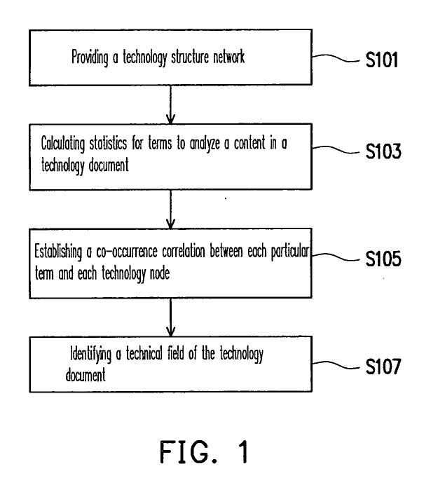

FIG. 1 illustrates a method for analyzing a technology document according to a preferred embodiment of the present invention. Referring to FIG. 1, first, in a step S101, a technology structure network is provided. The technology structure network has a plurality of technology category groups. Each of the technology category groups correspondingly represents a plurality of technology categories. Each of the technology categories has a technology hierarchical class and from top to bottom a plurality of technology levels. Each of the technology levels has at least one technology node.

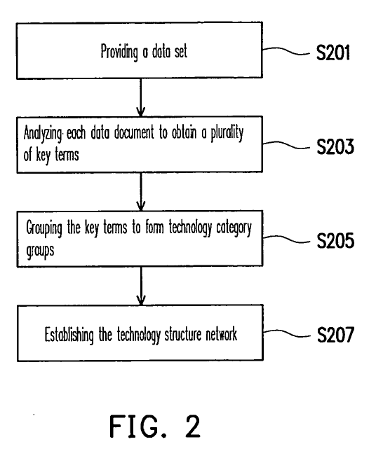

FIG. 2 illustrates a method for forming a technology structure network according to a preferred embodiment of the present invention. Referring to FIG. 2, a method for forming the technology structure network includes first, in a step S201, providing a data set according to a technical subject. The data set includes a plurality of data documents related to the technical subject.

Afterwards, in a step S203, each of the data documents is analyzed to obtain a plurality of key terms and a statistic for a term occurrence frequency of each of the key terms and a correlation between each of the key terms and the other key terms are calculated. Moreover, according to another embodiment, in the step S203, while the correlation between each of the key terms and the other key terms is analyzed, a particular correlation between each of the key terms and the technical subject is further analyzed. The particular correlation includes a correlation between a definition of each of the particular terms and the technical subject. For example, when the technical subject is a digital versatile disk (DVD), a correlation between a definition of the key term “optical” and the technical subject DVD is a particular correlation.

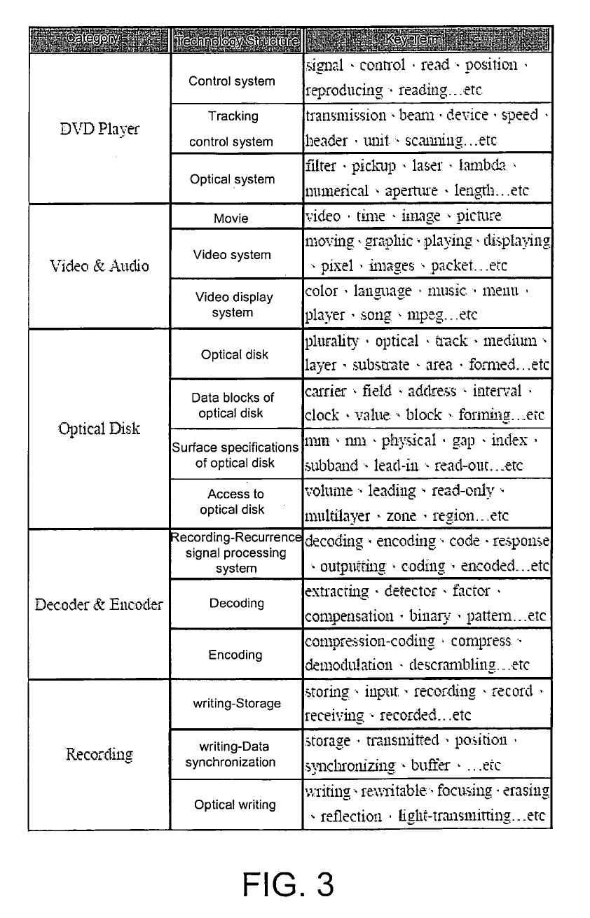

Subsequently, in a step S205, the key terms are further grouped, which means defining a portion of the key terms as the technology categories respectively according to the term occurrence frequency of each of the key terms and the correlation. According to an embodiment of the present invention, the said grouping method further includes grouping each of the key terms according to a particular correlation between the key term and the technical subject. Afterwards, the other key terms are grouped into each of the technology category groups and the technology hierarchical classes in each of the technology category groups are established with the key terms in each of the technology category groups. FIG. 3 illustrates a technology structure table according to a preferred embodiment of the present invention. Referring to FIG. 3, according to an embodiment of the present invention, DVD is a technical subject. A data set regarding DVD as the technical subject is obtained by sifting through the patent database maintained by the United States Patent and Trademark Office (USPTO). Patent files in the data set are analyzed to obtain five technology category groups, and technology categories therein are DVD Player, Video & Audio, Optical Disk, Decoder & Encoder and Recording respectively. Each of the technology categories has a plurality of technology structures. In the present embodiment, DVD Player can be divided into three groups, Video & Audio into three groups, Optical Disk into four groups, Decoder & Encoder into three groups and Recording into three groups. The technology structures are divided into sixteen types in total. Each of the technology structures further includes a plurality of related key terms correspondingly (i.e., terms enumerated in a key term column of FIG. 3).

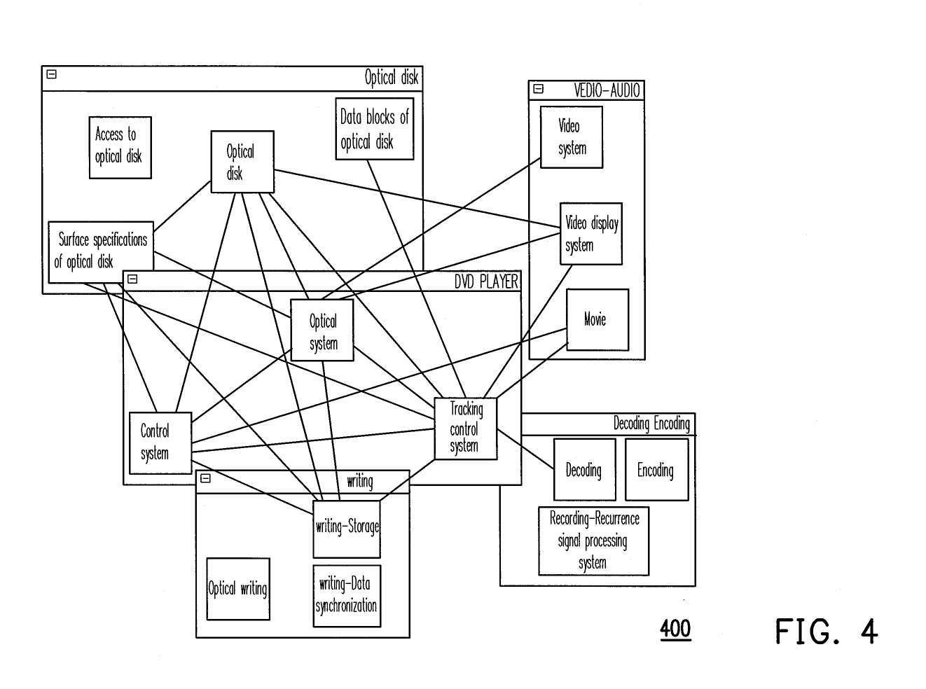

Then, in a step S207, a technology structure network is established based on correlations among technology nodes. FIG. 4 illustrates a technology structure network formed by the technology structures of FIG. 3. Referring to FIGS. 3 and 4, with DVD as a technical subject, five technology categories, DVD Player, Video & Audio, Optical Disk, Decoder & Encoder, and Recording, serve as parent levels. The plurality of technology structures in each of the technology categories serve as technology nodes in a first child-level under the parent levels. Each of the technology structures has a plurality of related key terms to serve as technology nodes (not shown) of a second child-level under the first child-level.

Taking technology hierarchical classes in the technology category of DVD Player as an example, DVD Player is a technology category level. In the technology category level, a parent node is used to represent a technology category (the parent node in the present embodiment is DVD Player). However, a first level under the parent node of DVD Player is a technology structure level including three technology structure elements of DVD Player serving as technology nodes of the technology structure level: a control system, a tracking control system, and an optical system. The second sub-level under the technology structure level is a related key term level. Likewise, the related key term level has a plurality of technology nodes, and each of the technology nodes in the related key term level represents a related key term. The related key term and a corresponding opposite parent node thereof (i.e., the technology node in the technology structure level) in this sub-level have a correlation. According to the present embodiment, a technology hierarchical class only includes three levels: a technology category level, a technology structure level and a related key term level. Nonetheless, the present invention is not limited thereto. In actual application, a number of levels in the technology hierarchical class may be increased according to each customization condition. In other words, related key terms in the related key term level may be further subdivided by at least one additional level.

Additionally, correlations also exist among the technology nodes of the same level or different levels in different technology category groups (such as the sixteen technology nodes in the technology structure level illustrated in FIG. 3). Therefore, technology categories related to the technical subject DVD may be interconnected through their correlations to form a technology structure network 400 related to the technical subject DVD as illustrated in FIG. 4. A connection between each of the technology nodes represents a correlation between the technology nodes. It is observed from the interconnection between the nodes in FIG. 4 that the technology category DVD Player is a primary core category of the technical subject DVD since all the connections have strong correlations with technology nodes in a next technology structure level with DVD Player as the parent node.

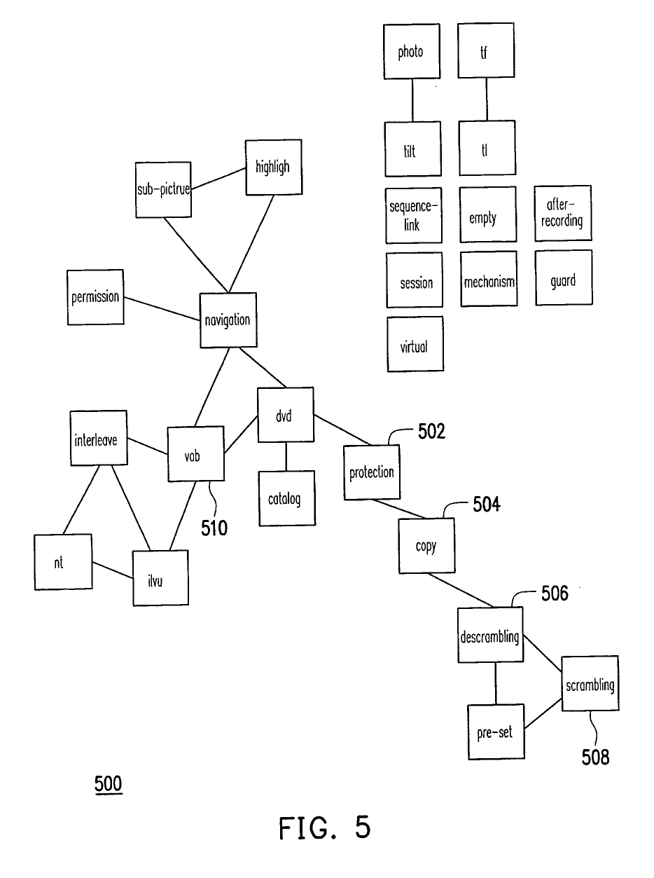

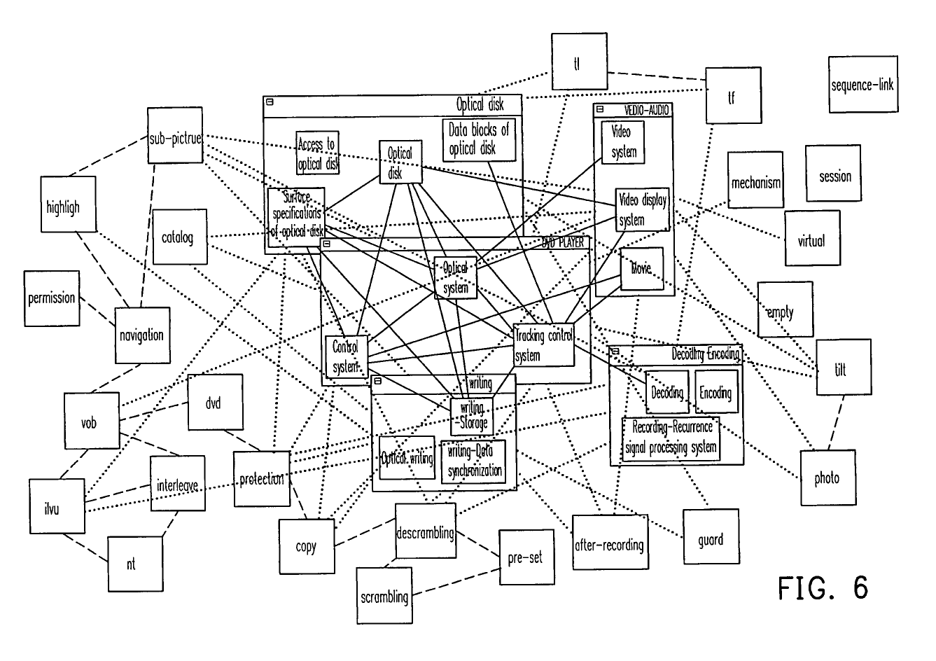

In the step S101, after a technology structure network is provided, referring to FIG. 1, in a step S103, statistics for the terms in the technology document to be analyzed are calculated to analyze the content of the technology document. At least one particular term is sifted out from the technology document. The key terms obtained from analyzing technology documents in the data set do not include the particular terms obtained from analyzing the technology document. Alternatively speaking, the particular terms sifted out from analyzing the technology document include rare key terms of low occurrence frequency or use frequency or latest created terms. FIG. 5 illustrates a simplified relation diagram among particular terms of a technology document according to a preferred embodiment of the present invention. Referring to FIG. 5, each node therein, such as nodes 502, 504, 506, 508 and 510, represents a particular term in the technology document to be analyzed and a correlation among the interconnected nodes is represented by an interconnection among each of the nodes. Thereby, a particular term network 500 of the technology document of FIG. 5 is formed.

Subsequently, in a step S105, a co-occurrence correlation is established between each of the particular terms and each of the technology nodes in the technology structure network. In the step S105, the co-occurrence correlation is established between each particular term node in the particular term network 500 of FIG. 5 and each of the technology nodes in the technology structure network 400 of FIG. 4, i.e. a frequency of coexistence of the two. As a result, the technology structure network 400 of FIG. 4 and the particular term network 500 of FIG. 5 are interconnected.

Next, in a step S107, each of the particular terms is identified as directed towards which technical field in the technology categories of the technical subject according to the aforementioned co-occurrence correlation. From the technical field of each of the particular terms, a technical field of the technology document is thereby identified.

According to an embodiment of the present invention, referring to FIG. 5, key terms (or technology nodes) related to data protection include protection (the technology node 502), descrambling (the technology node 506), scrambling (the technology node 508) and copy (the technology node 504). A content scrambling system is an important method for protecting DVD data. Files are encoded to prevent users from duplicating data on a DVD. Hence, descrambling (the technology node 506) is correlated to the categories of Disk and Encoding & Decoding. Accordingly, through interconnection between the technology structure network 400 and latest created key terms, protection (the technology node 502), descrambling (the technology node 506), scrambling (the technology node 508) and copy (the technology node 504), a latest developing technology used for protecting the data on the DVD is discovered.

According to another embodiment of the present invention, referring to FIG. 5, a particular term “VOB” (video objects) can be found in the particular term network 500. By referring to the co-occurrence correlation established between each particular term node in the particular term network 500 of FIG. 5 and each of the technology nodes in the technology structure network 400 of FIG. 4, VOB is solely connected to the technology category Video & Audio, which shows that VOB may be an important key term in video-audio display.

In the present invention, term frequencies of the terms in the data documents of the data set are calculated to establish a technology structure network. After the term frequencies of a technology document are analyzed, a particular term network of the technology document is established. Through interconnecting the nodes representing the particular terms in the particular term network to each of the technology nodes in the technology structure network respectively, a related technical field of the particular terms in the technology document is clearly identified and a trend of technology research and development implied in the technology document is promptly grasped so as to discover an emergent technology related to the technical field.

Although the present invention has been disclosed above by the preferred embodiments, they are not intended to limit the present invention. Anybody skilled in the art can make some modifications and alterations without departing from the spirit and scope of the present invention. Therefore, the protecting range of the present invention falls in the appended claims.

What is claimed is:

1. A method for analyzing a technology document, adapted to a technology document, comprising:
providing a technology structure network, wherein the technology structure network has a plurality of technology category groups representing a plurality of technology categories respectively, each of the technology category groups is a technology hierarchical class having a plurality of technology levels from top to bottom, each of the technology levels having at least one technology node;
performing a term statistic to analyze a content of the technology document so as to find out at least one particular term therefrom;
establishing a co-occurrence correlation between each of the particular terms and each of the technology nodes in the technology structure network; and
identifying a technical field to which the technology document belongs according to the co-occurrence correlation.

2. The method for analyzing the technology document as claimed in claim 1, wherein a method for forming the technology structure network comprises:
providing a data set according to a technical subject, wherein the data set comprises a plurality of data documents related to the technical subject;
analyzing each of the data documents to obtain a plurality of key terms;
grouping the key terms to form the technology category groups; and
establishing the technology structure network according to a correlation between each of the technology nodes.

3. The method for analyzing the technology document as claimed in claim 2, wherein the key terms do not comprise the particular terms.

4. The method for analyzing the technology document as claimed in claim 2, wherein analyzing each of the data documents further comprises: calculating statistics for a term occurrence frequency of each of the key terms and the correlations between the key terms.

5. The method for analyzing the technology document as claimed in claim 4, wherein analyzing each of the data documents further comprises: analyzing a particular correlation between each of the key terms and the technical subject.

6. The method for analyzing the technology document as claimed in claim 4, wherein grouping the key terms to form the technology category groups further comprises: defining a portion of the key terms as the technology categories respectively according to the term occurrence frequency of each of the key terms and the correlations.

7. The method for analyzing the technology document as claimed in claim 6, wherein grouping the key terms further comprises grouping the key terms according to the particular correlations between each of the key terms and the technical subject.

8. The method for analyzing the technology document as claimed in claim 6, wherein grouping the key terms to form the technology category groups further comprises: after the key terms being defined as the technology categories respectively, grouping the key terms to each of the technology category groups and establishing the technology hierarchical class of each of the technology category groups with the key terms within each of the technology category groups.

9. The method for analyzing the technology document as claimed claim 6, wherein in each of the technology hierarchical classes, the technology category serves as a parent level, and each of the technology categories has a plurality of technology structures as the technology nodes of a first child-level under the parent level.

10. The method for analyzing the technology document as claimed in claim 9, wherein each of the technology structures has a plurality of related key terms as the technology nodes of a second child-level under the first child-level.

11. The method for analyzing the technology document as claimed in claim 1, wherein identifying the technical field of the technology document further comprises: identifying the technical field related to the particular key terms.

12. The method for analyzing the technology document as claimed in claim 1, wherein the particular terms comprise rare key terms or latest created terms.

13. A method for analyzing a technology document, adapted to a technology document, comprising:
providing a technology structure network, wherein the technology structure network has a plurality of technology hierarchical classes, each of the technology hierarchical classes at least comprising:
a technology category level, wherein the technology category level has a parent node to represent a technology category;
a technology structure level being a first sub-level of the technology category level, the technology structure level having a plurality of first technology nodes, wherein each of the first technology nodes represents a technology structure element of the technology category;
a related key term level being a second sub-level of the technology structure level, the related key term level having a plurality of second technology nodes, each of the second technology nodes representing a related key term, the related key term being correlated to the first technology node which is a corresponding parent node for the second technology node;
performing a term statistic to analyze a content of the technology document and sifting out at least one particular term therefrom;
establishing a co-occurrence correlation between each of the particular terms and at least one among the first technology nodes and the second technology nodes in the technology structure network; and
identifying a technical field to which the technology document belongs according to the co-occurrence correlations.

14. The method for analyzing the technology document as claimed in claim 13, wherein a method for forming the technology structure network comprises:
providing a data set according to a technical subject, wherein the data set comprises a plurality of data documents related to the technical subject;
analyzing each of the data documents to obtain a plurality of key terms;
grouping the key terms to form the technology hierarchical classes; and
establishing the technology structure network according to a correlation among each of the technology nodes.

15. The method for analyzing the technology document as claimed in claim 14, wherein the key terms do not comprise the particular terms.

16. The method for analyzing the technology document as claimed in claim 14, wherein analyzing each of the data documents further comprises: calculating statistics for a term occurrence frequency of each of the key terms and the correlation between the key terms.

17. The method for analyzing the technology document as claimed in claim 16, wherein analyzing each of the data documents further comprises: analyzing a particular correlation between each of the key terms and the technical subject.

18. The method for analyzing the technology document as claimed in claim 16, wherein grouping the key terms to form the technology hierarchical classes further comprises: defining a portion of the key terms as the technology categories respectively according to the term occurrence frequency of each of the key terms and the correlation.

19. The method for analyzing the technology document as claimed in claim 18, wherein grouping the key terms further comprises grouping the key terms according to the particular correlation between each of the key terms and the technical subject.

20. The method for analyzing the technology document as claimed in claim 18, wherein grouping the key terms to form the technology hierarchical classes further comprises: after the portion of the key terms being defined as the technology categories respectively, grouping the key terms into each of the technology categories and establishing each of the technology hierarchical classes with the key terms of each of the technology categories.

21. The method for analyzing the technology document as claimed in claim 13, wherein each of the first technology nodes has at least one of the second technology nodes as a sub-node of the first technology node.

22. The method for analyzing the technology document as claimed in claim 13, wherein identifying the technical field of the technology document further comprises: identifying the technical field related to the particular key terms.

23. The method for analyzing the technology document as claimed in claim 13, wherein the particular terms comprise rare key terms or latest created terms.
